(19) United States
(12) Patent Application Publication
(10) Pub. No.: US 2002/0005006 A1
(43) Pub. Date: Jan. 17, 2002

(54) Anti-bug globe

(76) Inventor: Ronnie Phillips, Monroe, NC (US)

Correspondence Address: Ronnie D. Phillips, 4519 SPRINGVIEW DR., MONROW, NC, 28112, US

(21) Appl. No.: 09/805,541

(22) Filed: Mar. 13, 2001

Related U.S. Application Data
(60) Provisional application No. 60/189,651, filed on Mar. 15, 2000.

(51) Int. Cl. A01M 1/04; A01M 1/08

(52) U.S. Cl. 43/113

(57) ABSTRACT

An improved lantern globe infused an amber dye which blocks the visual spectrum of light an insect can see without diminishing the spectrum of light a human can see. The dye is infused into pyrex glass at approximately a 1200 F. temperature and permanently binds the expanded glass molecules to the dye. This makes the glass stronger and prevents the dye from being burned or scratched off and makes breakage less frequent. The resulting tint, after the glass is cooled, is transparent not translucent. This allows the full spectrum of light visible to humans to pass through the globe undiminished and provide a dramatically bright light source. The use of the globe replaces the need for costly and dangerous bug-repellent chemicals.

### BACKGROUND

1. Field of Invention

This invention relates to a tinted globe which can be fitted onto an existing outdoor lantern. A major problem of existing lantern globes are their propensity to attract enormous numbers of insects to the bright light. This is a dangerous problem which is a nuisance to campers and hunters. The insects swarm around the lantern blocking the available light creating a dangerous blockage of light. It is imperative a camper or hunter have sufficient light available when they are walking around in the dark in unfamiliar territory. Heretofore, noxious and costly chemicals were used to repel the insects. This presents significant health concerns for humans and animals and only has a small deterrent effect on the swarming insects.

### DESCRIPTION OF INVENTION

My invention provides a safe economical solution to this problem. The tinted globe has an amber dye infused inside the glass. Pyrex glass is used because it is stronger than tempered glass. It can be heated to high temperatures at which the glass molecules can be expanded enough to readily accept the infusion of the amber dye. When cooled, the globe is transparent not translucent. The resulting globe eliminates the visual spectrum of light seen by insects without diminishing the spectrum of light seen by humans. Costly and dangerous pesticides are not needed.

2Description of Prior Art

Heretofore many different arrangements were used to repel insects from a light emitting source. There is a specific need for an object that filters out the exact spectrum of light which an insect is capable of seeing. Additionally, the filtering object must not block the spectrum of light which a human needs to adequately see in a darkened area. The prior art contains examples of this concept but fails to produce the desired result due to the type of filtration method used. This results in very limited spectrum of available light emitted for human vision. Another unique need, not addressed by the prior art, is the necessity of maintaining sufficient glass strength and continued filtration over the course of use. The following is a discussion of these arrangements and their drawbacks:

One arrangement involved a lantern with a restricted airflow channel. It is located directly under the light source. Patti U.S. Pat. No. 5,014,460 (1991) utilizes a motor to funnel the airflow at a high velocity and kill the insects when they are caught in the air-stream. This is an expensive and noisy method to use and produces the majority of its light in a downward vertical array.

A similar arrangement is Bradley U.S. Pat. No. 5,274,609 (1993). However, instead of a high velocity air stream, Bradley uses fire to kill the insects. Two doors are mounted upon a glass globe and opened to allow the insects to fly inside of the globe and be combusted by the lantern flame. Bradley's design also has the advantage of reflecting additional light produced by the polished doors when they are utilized. Neither Patti or Bradley focus upon eliminating the source of light which draws the insects near the lantern.

Leonard U.S. Pat. No. Des. 422,735 (2000) attempts to eliminate the vertical light source by providing longitudinal horizontal slits on the top of the lantern. This focuses the light into a vertical beam which projects upward above the lantern. This causes the insects to be attracted to a light source above the lantern and away from the base. This may result in decreased insects around the lantern base but provides a poor light source for the user of the lantern.

Sapp U.S. Pat. No. 5,105,344 (1992) attempts to overcome this difficulty by coating the lantern glass a yellow hue and incorporating an insect repellent substance therein. Although this reduces the spectrum of light it only has a marginal effect on repelling insects and relies primarily upon the insect repellent substance. The yellow coating is applied to the outer surface of the glass and is easily scratched or burned off and quickly loses its shielding properties with increased use of the lantern. It does not let the heat of the fire dissipate and makes the glass more brittle and easy to break. The resulting heat distorts the color of the glass and renders it almost ineffective against repelling insects. Thus the primary deterrence is the insect repellent substance incorporated into the glass.

### OBJECTS AND ADVANTAGES

Accordingly, several objects and advantages of my invention are to provide an improved retardation of the light source to repel all insects. This is accomplished by infusing an amber dye into the glass. This method is superior to Sapp because my tint can not be scratched or burned off and provides a uniform rate of heat dissipation to prevent damage to the tint. Sapp's invention generates a translucent light which is partially blocked by the insect repellent substance incorporated into the glass. My invention produces a transparent medium to facilitate maximum filtration of light. This overcomes the limitation of a low yield of available light which Sapp's invention dampens. Additionally, the available spectrum of light seen by insects is virtually eliminated without sacrificing any light source for humans. This increased light source is critical for hunters who are tracking animals and emergency situations where a camper has to have immediate access to a bright light source. It allows a hunter to track a blood path of a wounded animal better because the blood spots change color from red to black and are more easily noticed. Because the heat is easily dissipated by my invention there is no degradation of the amber hue and insect repelling properties. The amber hue also has the additional effect of being more pleasant to a human's spectrum of vision and thus minimizes the amount of strain on the eyes. This allows seeing impaired people an opportunity to spend time outdoors at night and lead a fuller lifestyle. Another advantage of my invention is the increased strength of the glass. The amber dye is infused into the glass at a very high temperature and strengthens the bonding attraction between the glass molecules. This makes the glass much more strong and resilient to changes in temperature and moisture which may crack or degrade the integrity of the glass. This is extremely important in the activity of camping or hunting where the lantern is often jostled around and needs to be strong enough to endure the rigors of hard physical use. Sapp uses tempered glass for his lantern which shatters easily and is dangerous. My invention uses safer pyrex glass which can be heated to approximately 1200 degrees F. The amber dye can only be infused into the glass molecules at this high temperature. Sapp's invention has a chemical repellent inside the glass and is thus not environmentally friendly. My invention prevents the attraction of bugs without the use of dangerous pesticides. Furthermore, it is stronger, cheaper, more durable and provides dramatically more light for humans to use when camping or hunting. Because it is the exact size and shape of most existing lantern globes, the familiar shape facilitates easier maintenance and safer replacement.

### BRIEF DESCRIPTION OF THE DRAWING

FIG. 1 is a view of the globe with a cross-section cut-away view of the inside of the globe showing the glass molecules and the amber dye.

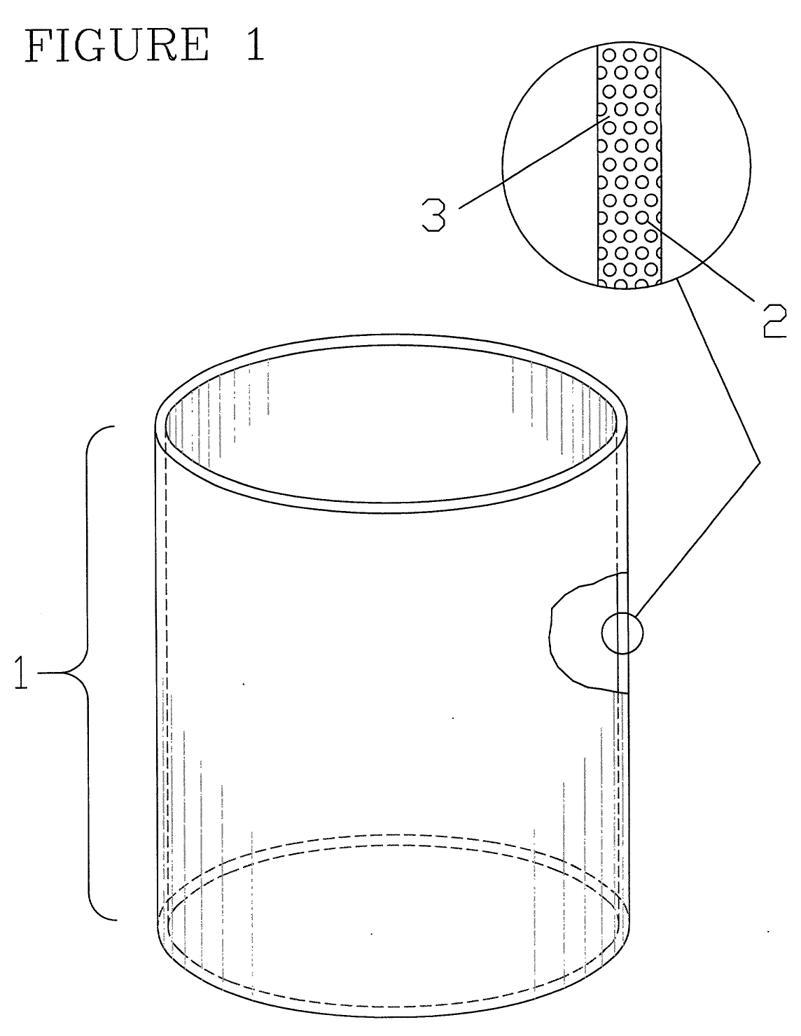

### PREFERRED EMBODIMENT—DESCRIPTION

Operation and use of the undergarment is simple and straightforward. At a very high temperature the amber dye, 3, is infused into the glass molecules, 2, of the pyrex globe, 1. The globe, 1, is then mounted upon an outdoor lantern. When the lantern is lit, the globe, 1, filters out the spectrum of light an insect is capable of seeing without diminishing the available spectrum of light used by humans to see.

### CONCLUSIONS, RAMIFICATIONS AND SCOPE

My invention provides a transparent glass medium through which the available spectrum of light for insects is filtered out without degradation of the available spectrum of light humans need to see in the dark. It is an improved globe for outdoor lanterns which is stronger, cheaper and allows substantially more light for campers and hunters to use. Although the description above contains many specificities, these should not be construed as limiting the scope of the invention but a merely providing illustrations of some of the presently preferred embodiments of this invention. Various other embodiments and ramifications are possible with it's scope.

Thus the scope of the invention should be determined by the appended claims and their legal equivalents, rather than by the examples given.

What is claimed is:

1. A cylindrical pyrex globe having an amber dye infused into said globe where said globe is the exact size of most outdoor lantern globes.

2. The globe of claim 1 where said globe is of flat configuration and can be used as a face-plate for any electronic or mechanical device.
